(19) United States
(12) Patent Application Publication
(10) Pub. No.: US 2005/0138565 A1
(43) Pub. Date: Jun. 23, 2005

(54) System and method for changing the sensitivity of graphic control devices

(76) Inventor: Denny Jaeger, Oakland, CA (US)

Correspondence Address: Wilson & Ham, PMB: 348, 2530 Berryessa Road, San Jose, CA, 95132, US

(21) Appl. No.: 10/740,785

(22) Filed: Dec. 18, 2003

(51) Int. Cl. G06F 3/00; G11B 27/00

(52) U.S. Cl. 715/747; 715/764; 715/716; 715/719; 715/720; 715/721; 715/722; 715/727; 715/786; 715/707

(57) ABSTRACT

A system and method for changing the sensitivity of a graphic control device, such as a fader or a scroller, involves automatically changing the effective control range of the graphic control device from a first effective control range to a second effective control range in response to a user input. The second effective control range may be shorter than the first effective control, allowing for more sensitive or “fine” control of the graphic control device. The changed effective control range of the graphic control device may be defined by a programmable scaling factor of the original effective control range.

### FIELD OF THE INVENTION

The invention relates generally to computer programs, and more particularly to computer programs that display graphic control devices, such as faders and scrollers.

### BACKGROUND OF THE INVENTION

Graphic control devices, such as faders and scrollers, are used in various computer applications to perform predefined functions. As an example, an audio player application may include a volume control fader, a balance control fader, a bass control fader, and a treble control fader. The effective control range of a graphic fader is pre-established and usually cannot be changed by a user. Since the sensitivity of a graphic fader tends to decrease with increases in effective control range, a graphic fader with a large effective control range may not have the desired sensitivity for a user to manipulate that fader to a precise setting.

Graphic scrollers are commonly found in computer application windows, such as word processing application windows. In a word processing application window, a vertical scroller allows a user to scroll a long electronic document so that a desired portion of the document can be viewed in the window. The effective control range of a vertical scroller on a word processing application window typically spans the entire length of the electronic document. Thus, for a long electronic document, the sensitivity of the scroller can make it difficult to scroll to a precise location in the document.

Furthermore, when using a graphic fader to control audio, video or graphic functions, the same problem occurs, which is often more of a limitation. For instance, using a graphic fader of a set length to make very minute adjustments in the volume or equalization of a sound file or to very carefully adjust the contrast, hue, saturation or color of a photograph or video frame can be very difficult, if not impossible. There may be just not enough resolution to make the desired very small increments of change with any controllable accuracy.

In view of these disadvantages, what is needed is a system and method for changing the sensitivity of graphic control devices such that user can manipulate the control devices to precise settings.

### SUMMARY OF THE INVENTION

A system and method for changing the sensitivity of a graphic control device, such as a fader or a scroller, involves automatically changing the effective control range of the graphic control device from a first effective control range to a second effective control range in response to a user input. The second effective control range may be shorter than the first effective control, allowing for more sensitive or “fine” control of the graphic control device. The changed effective control range of the graphic control device may be defined by a programmable scaling factor of the original effective control range.

A system for changing the sensitivity of a graphic control device in accordance with an embodiment of the invention includes a display configured to display the graphic control device having a first effective control range, the first effective control range having corresponding first and second control limits, and a device programming module configured to automatically change the first effective control range of the graphic control device to a second effective control range in response to a user input, the second effective control range having corresponding first and second control limits.

A method for changing the sensitivity of a graphic control device in accordance with an embodiment of the invention includes displaying the graphic control device having a first effective control range on a display, the first effective control range having corresponding first and second control limits, and automatically changing the first effective control range of the graphic control device to a second effective control range in response to a user input, the second effective control range having corresponding first and second control limits.

An embodiment of the invention includes a storage medium, readable by a computer, tangibly embodying a program of instructions executable by the computer to perform the method steps for changing the sensitivity of a graphic control device.

Other aspects and advantages of the present invention will become apparent from the following detailed description, taken in conjunction with the accompanying drawings, illustrated by way of example of the principles of the invention.

### BRIEF DESCRIPTION OF THE DRAWINGS

FIGS. 1A-1D illustrate the proportional change in the effective control range of a graphic fader to change the sensitivity of the fader in accordance with an embodiment of the invention.

FIGS. 2A-2C illustrate the proportional change in the effective control range of a graphic scroller of a [Virtual or Visual] Display and Control Canvas (VDACC) object to change the sensitivity of the scroller in accordance with an embodiment of the invention.

FIGS. 3A-3C illustrate the corresponding change in the scrollable portion of the workspace surface of the VDACC object when the effective control range of the graphic scroller is changed as shown in FIGS. 2A-2B.

FIGS. 4A-4E illustrate the change in the effective control range of a graphic scroller with fixed differentials to change the sensitivity of the scroller in accordance with an embodiment of the invention.

FIGS. 5A-5E illustrate the corresponding change in the scrollable portion of the workspace surface of the VDACC object when the effective control range of the graphic scroller is changed as shown in FIGS. 4A-4E.

FIGS. 6A-6C illustrate the process of placing a scroller maker in accordance with an embodiment of the invention.

FIGS. 7A-7C illustrate the position of the scroller marker with respect to the workspace of the display and control canvas object when the scroller marker is placed on the scroller as shown in FIGS. 6A-6C.

FIG. 8 is a diagram of a computer system in which the method for changing the sensitivity of graphic control devices in accordance with an embodiment of the invention has been implemented.

FIG. 9 is a flow diagram of a method for changing the sensitivity of a graphic control device in accordance with an embodiment of the invention.

### DETAILED DESCRIPTION

A method for changing the sensitivity of a graphic control device in accordance with an embodiment of the invention involves automatically changing the effective control range of the graphic control device, such as a fader or a scroller, in response to a user input so that the sensitivity of that device can be correspondingly changed. The method is described herein with reference to graphic faders and graphic scrollers. However, the method can be applied to any graphic control device that can be graphically manipulated by a user. The graphic control device exists in a computer operating environment. As an example, the computer operating environment may be a “Blackspace” environment. The word “Blackspace” is a trademark of the NBOR Corporation. The Blackspace environment presents one universal drawing surface that is shared by all graphic objects within the environment. The Blackspace environment is analogous to a giant drawing “canvas” on which all graphic objects generated in the environment exist and can be applied. Each of these graphic objects can have a user-created relationship to any or all the other objects. There are no barriers between any of the objects that are created for or exist on this canvas. However, the method is not limited to the Blackspace environment and can be used in any computer operating environment.

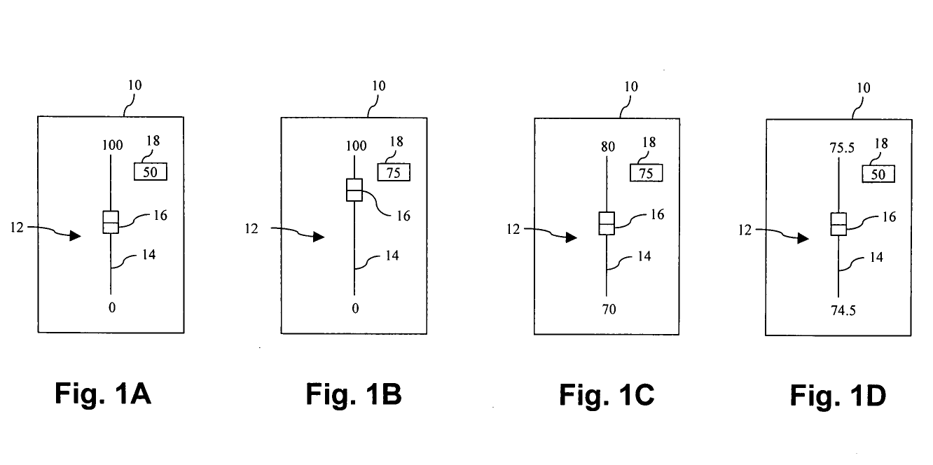

FIGS. 1A-1D show a display area 10 in which a graphic control device 12 is displayed. In the example of FIGS. 1A-1D, the graphic control device 12 is a fader, which is graphically depicted in the display area 10 by a fader track 14 and a fader cap 16. The fader cap 16 can be graphically moved by a user along the length of the fader track 14 using a cursor (not shown) or using a finger on a touch panel (not shown) to adjust the setting of the fader 12. The fader 12 has an effective control range, which is defined by the control limits at each end of the fader track 14. For example, the fader 12 has a maximum control limit at the top of the fader track 14 and a minimum control limit at the bottom of the fader track. The effective control range of the fader 12 may be variably programmable by a user.

Because the fader 12 is a graphically displayed control device, there are many different options as to what graphics can be displayed in conjunction with the fader. Graphics that can be displayed in conjunction with the fader 12 include any combination of the current value of the fader, the maximum control limit of the fader, and the minimum control limit of the fader. These values can be displayed in terms of absolute values, relative values, percentages, etc. In one embodiment, only the current value 18 of the fader 12 is displayed with the fader. The current value 18 is adjusted in real-time in response to movement of the fader cap 16. For description purposes, FIGS. 1A-1D also depict the maximum and minimum control limits (e.g., 100 and 0) for the fader 12, although these values may not necessarily be displayed in the display area 10. The current fader value 18 associated with the fader 12 may have different significance. For example, the current fader value 18 may represent a sound level, temperature, color, number, etc. Alternatively, the fader 12 may not identify any particular value and may simply be a relative scale between a first control limit and a second control limit. In the example of FIGS. 1A-1D, the display area 10 is provided through a display device such as a computer monitor, a person digital assistant (PDA) display, or some other graphic display device.

A method for changing the sensitivity of the fader 12 in accordance with the invention is now described with reference to FIGS. 1A-1D. At FIG. 1A, the effective control range of the fader 12 is from “0” to “100” and the fader is currently set to a value of “50”. At FIG. 1B, the fader cap 16 has been moved to a position corresponding to a fader value of “75”. Subsequently, a user input is initiated that causes the effective control range of the fader 12 to change. The user input may involve a mouse click and/or a key stroke. As shown in FIG. 1C, the effective control range of the fader 12 has changed in proportion to the original effective control range by a factor of 1/10. The resulting effective control range spans from “70” to “80”. That is, the effective control range now has a maximum control limit of 80 and a minimum control limit of 70. With the change in the effective control range, the fader cap 16 may be moved to the center of the fader track 14, as shown in FIG. 1C. However, the current value 18 remains at “75”. The fader 12 can now be adjusted in the range of “70” to “80” by graphically moving the fader cap 16 along the entire length of the fader track 14. The new effective control range provides for more sensitive or “fine” control of the fader 12 than the original effective control range. Thus, the new effective control range of the fader 12 allows the user to manipulate the fader to a more precise setting.

Although in this embodiment, the effective control range of the fader 12 is changed by a factor of 1/10, the scaling factor may be user-definable and programmable. Alternatively, as described below, the effective control range can be changed in a non-proportional manner with respect to the original effective control range.

The effective control range of the fader 12 can be changed to provide even more sensitive control. For example, another user input can be initiated that causes the fader 12 to change again by the same factor or some other factor. That is, the effective control range of the fader 12 can be changed in proportion to the current effective control range by another factor of 1/10 with the effective control range of the fader being centered at the current value. FIG. 1D shows the effective control range of the fader 12 after a second 1/10 change. The new effective control range is now from “74.5” to “75.5”. Thus, the fader 12 can be adjusted in the range of “74.5” to “75.5” by graphically moving the fader cap 16 along the length of the fader track 14.

The process of changing the effective control range of the fader 12 can be repeated until the desired level of sensitivity is obtained. The effective control range can also be changed in the opposite direction (i.e., to a longer effective control range) by a designated user input. The user inputs that can be used to change the effective control range may include any input from an input device (e.g., a mouse click and/or a key stroke). In the exemplary embodiment, a single mouse click on or near the fader track 14 while the shift key is depressed changes the effective control range from a first effective control range to a second effective control range and a subsequent mouse click on or near the fader track while the shift key is depressed returns the effective control range back to the first effective control range. Furthermore, to increase the effective control range of the fader 12 by an additional factor of 10/1, a user could hold down another key, e.g., the ctrl key, (after the first change in effective control is effected by holding down the shift key and clicking on or near the fader). As a result, the effective control range of the fader 12 would be further increased, as in this example, to 20/1.

In some embodiments, the size of the displayed fader 12 affects the effective control range. Thus, the effective control range of the fader 12 in FIGS. 1D may be increased or decreased by changing the size of the fader. As an example, if the length of the fader track 14 is elongated to be twice the current length, then the effective control range of the fader 12 is increased from the current effective control range of 74.5 to 75.5 to a new effective control range of 74 to 76, which is twice the current effective control range. However, the sensitivity of the fader 12 is not changed. In other embodiments, the size of the displayed fader 12 does not affect the effective control range. In these embodiments, any change in the size of the fader 12 only affects the sensitivity of the fader, not the effective control range of the fader.

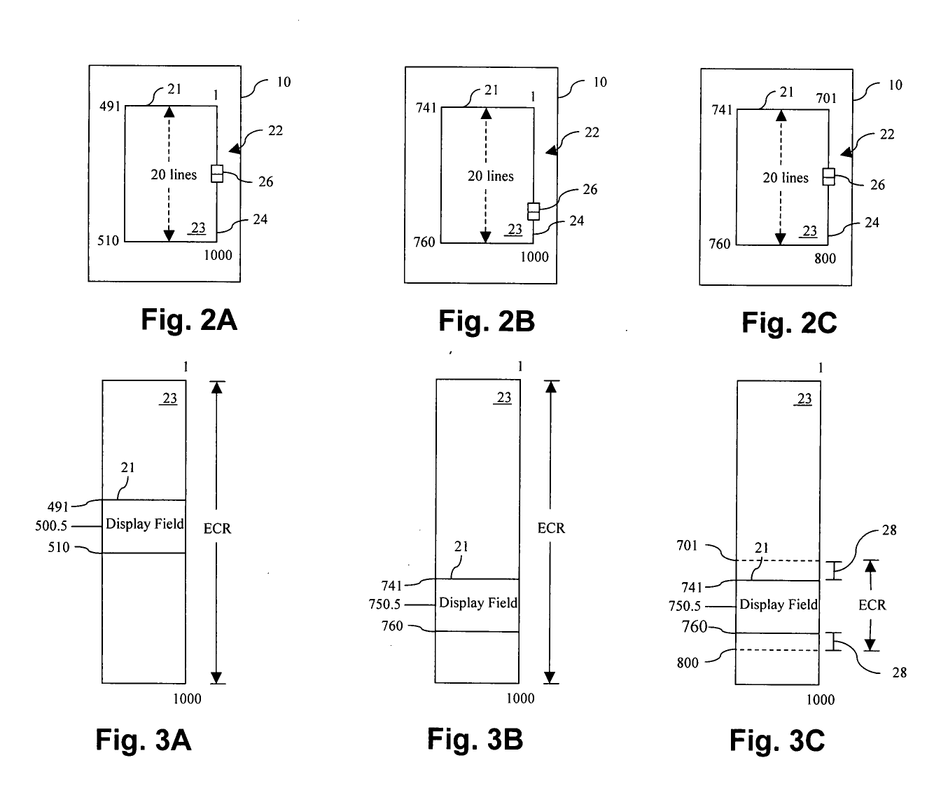

In FIGS. 1A-1D, the effective control range of the fader 12 was changed to increase or decrease the sensitivity of the fader. However, the same method can be applied to change the effective control range of any graphic control device, and thus, the sensitivity of that device. In FIGS. 2A-2C, the effective control range of a graphic control device in the form of a scroller 22 of a [Virtual or Visual] Display and Control Canvas (VDACC) object 21 can be changed to increase or decrease the sensitivity of the scroller. The term “VDACC” is a trademark of NBOR Corporation. A VDACC object includes a workspace surface or canvas that may be larger than the visible or viewable area of the VDACC object. Thus, a VDACC object allows a user to scroll the visible area to view graphic objects or contents in the VDACC object that were hidden from the visible area. However, the objects that appear to be in the VCACC object exist on the global Blackspace canvas. For more information about VCACC objects, see pending U.S. patent application Ser. No. 10/671,953, entitled “Intuitive Graphic User Interface with Universal Tools”, filed Sep. 26, 2003, which is incorporated by reference herein.

The scroller 26 is a scrolling element that can be used to scroll through the workspace surface 23 of the VDACC object 21 when the viewable area of the VDACC object is not large enough to display the entire workspace surface. The scroller 22 includes a scroller track 24 (which in this case is a one pixel edge of the VDACC object 21) and a scroller cap 26. The scroller cap 26 can be graphically moved along the length of the scroller track 24 to scroll the viewable area of the VDACC object 21 through the workspace surface 23 so that the user can view a desired portion of the workspace surface. Similar to the graphic fader 12, the effective control range of the scroller 22 is defined by control limits at each end of the scroller track. For example, the scroller 22 has a first control limit at the top of the scroller track 24 and a second control limit at the bottom of the scroller track.

FIGS. 3A-3C illustrate the change in the effective control range of the scroller 22 with respect to the entire workspace surface 23 of the VDACC object 21.

FIGS. 3A-3C correspond to FIGS. 2A-2C, respectively. The workspace surface 23 of the VDACC object 21 may include any graphic objects, such as text, images, graphics, etc. In the example of FIGS. 3A-3C, the workspace surface 23 is larger 30 than the viewable area of the VDACC object 21. Thus, only a portion of the workspace surface 23 can be displayed within the viewable area of the VDACC object 21 at any one time. The portion (“display field”) of the workspace surface 23 that is displayed within the viewable area of the VDACC object 21 in FIGS. 2A-2C is correspondingly depicted in FIGS. 3A-3C. For description purposes, the workspace surface 23 is assumed to include text and the viewable area of the VDACC object 21 is assumed to display twenty lines of text at a time.

Because the scroller 22 is a graphically displayed control device, there are many different options as to what graphics can be displayed in conjunction with the scroller. Graphics that can be displayed in conjunction with the scroller 22 may be numbers related to the text lines of the workspace surface 23 of the VDACC object 21. These graphics include any combination of the current text line number that the scroller 22 is centered on, the line number of the first control limit, the line number of the second control limit, and the line numbers of the displayed lines of text in the viewable area of the VDACC object 21. In FIGS. 2A-2C, for description purposes, the line numbers of the first control limit and the second control limit are identified at the upper and lower right corners of the VDACC object 21, respectively. Additionally, the top and bottom displayed lines are identified at the upper and lower left corners of the VDACC object 21, respectively. It should be understood that any combination of these values may be displayed or none of these values may be displayed.

A method for changing the sensitivity of the scroller 22 in accordance with an embodiment of the invention is described with reference to FIGS. 2A-2C and 3A-3C. As shown in FIG. 2A, the original effective control range of the scroller 22 is from line 1 to line 1,000 and the scroller cap 26 is currently set at line 500.5 (i.e., midpoint between lines 500 and 501). The viewable area of the VDACC object 21 displays twenty lines of text centered at line 500.5 and therefore, in this example, the viewable area of the VDACC object displays lines 491 through 510. FIG. 3A shows the corresponding display field of the workspace surface 23, which is displayed in the viewable area of the VDACC object 21, and the effective control range (identified as “ECR” in the figures) of the scroller 22 relative to the workspace surface. In FIG. 2B, the scroller cap 26 is graphically moved to a position corresponding to line 750.5 such that the viewable area of the VDACC object 21 displays twenty lines of text from lines 741 to 760 centered at line 750.5. The corresponding FIG. 3B depicts the viewable area of the workspace surface 23 that has been moved according to the changed position of the scroller cap 26. As shown in FIG. 3B, the effective control range of the scroller 22 has not been changed.

In this example, a user input is then initiated that causes the effective control range of the scroller 22 to change. The user input may involve a mouse click and/or a keystroke. Referring to FIG. 2C, the effective control range of the scroller 22 is changed in proportion to the first effective control range by a factor of 1/10 with the effective control range being centered around the current position of the scroller cap 26 (i.e., line 750.5). As depicted in FIG. 2C, the effective control range of the scroller 22 is now one hundred lines, with a first control limit at line 701 and a second control limit at line 800. Corresponding FIG. 3C depicts the changed effective control range of the scroller 22 relative to the workspace surface 23. However, as shown in FIG. 3C, the display field that corresponds to the portion of the workspace surface 23 displayed in the viewable area of the VDACC object 21 has not been changed. With the changed effective control range, the scroller 22 can now be used to adjust the displayed lines of text within the range of lines 701 through 800. The new effective control range of the scroller 22 provides for more sensitive control of the scroller than the original effective control range. Similar to the effective control range of the fader 12, the effective control range of the scroller 22 can be changed by a different factor and/or changed multiple times to obtain the desired control sensitivity. Additionally, the effective control range of the scroller 22 can be changed back to a previous effective control range in response to a designated user input.

Referring to FIG. 3C, the difference between a boundary of the display field and the nearest control limit is referred to herein as the “differential” 28. In the example of FIG. 3C, there is an upper differential of forty lines and a lower differential of forty lines when the displayed text of twenty lines is centered at line 750.5. The upper differential is measured between the upper boundary of the viewable area (line 741) and the minimum control limit (line 701) and the lower differential is measured between the lower boundary of the display field (line 760) and the maximum control limit (line 800). In FIGS. 2C and 3C, the differential is a function of the scaling factor, and therefore, the differential is changed when the scaling factor is changed. For example, if the scaling factor is one-half of the original effective control range, then the changed effective control range would span five hundred lines. Assuming the viewable area remains unchanged at twenty lines, the upper and lower differentials will each be two hundred and forty lines.

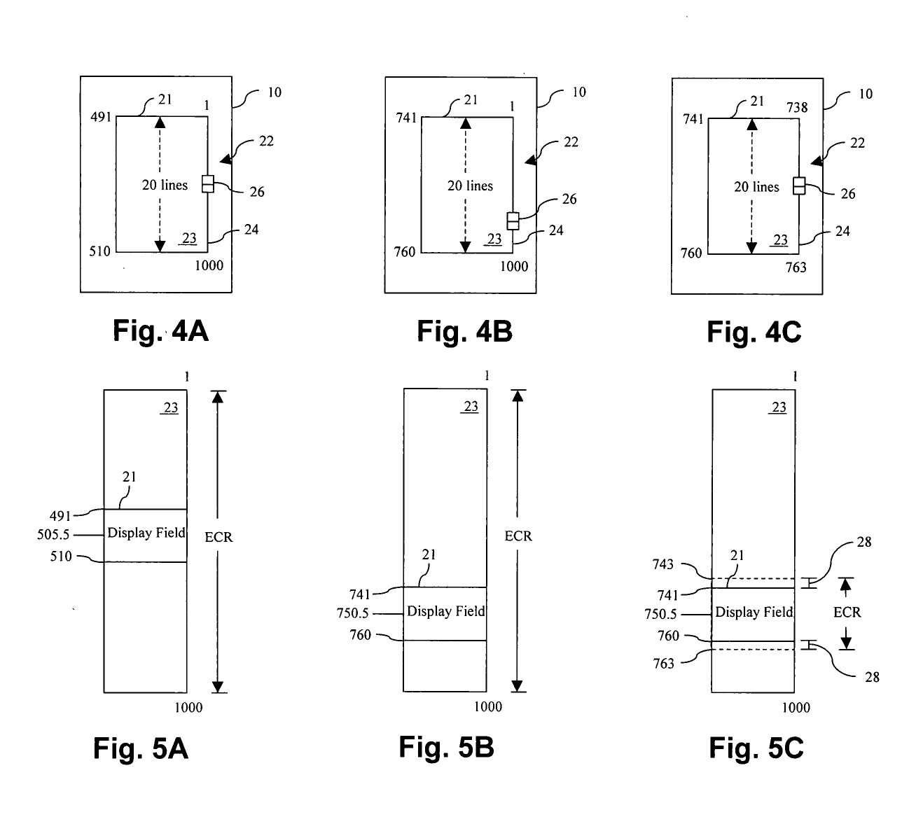

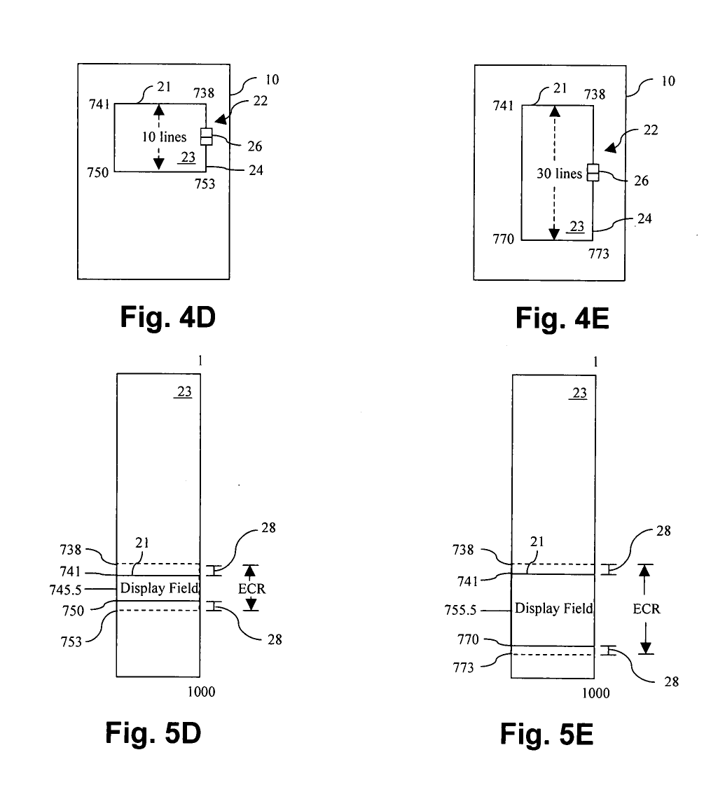

In another embodiment of the invention, the differential is set to a fixed value. That is, the differential is set to a value that is not a function of the scaling factor. An example of a method for changing the sensitivity of a graphic control device using changed effective control range with a fixed differential is described with reference to FIGS. 4A-4E and 5A-5E. FIGS. 4A, 4B, 5A, and 5B are same as FIGS. 2A, 2B, 3A, and 3B. With regard to FIGS. 4C and 5C, a user input is initiated which changes the effective control range of the scroller 22. In accordance with an embodiment of the invention, the effective control range of the scroller 22 is changed in response to a fixed differential value instead of a scaling factor. Using the fixed differential technique, the effective control range is determined as a function of the size of the viewable area of the VDACC object 21 and the differential value. In this exemplary embodiment, the effective control range is equal to the viewable area of the VDACC object 21 plus twice the differential value. The effective control range is set by subtracting the differential value from the top line that is in the viewable area and by adding the differential value to the bottom line that is in the viewable area. In the example of FIGS. 4C and 5C, the effective control range is changed in response to a fixed differential 28 of three lines. Referring to FIG. 5C, the effective control range is changed to an effective control range of twenty-six lines with a first control limit at line 738 and a second control limit at line 763. In the example, the first control limit at line 738 is set by subtracting three lines (the differential value) from line 741 and the second control limit at line 763 is set by adding three lines (the differential value) to line 760.

Using the differential technique to set the effective control range, the effective control range of a graphic control device will change in response to a change in size of the viewable area of a VDACC object. Referring to FIGS. 4D and SD, the effective control range of the scroller 22 is decreased when the viewable area of the VDACC object 21 has been decreased, for example, from twenty lines to ten lines. As depicted in FIG. 4D, the viewable area of the VDACC object 21 has been reduced such that only ten lines are displayed. The ten lines span from line 741 to line 750 and are centered at line 745.5. Using the fixed differential technique, the new effective control range is still equal to the viewable area of the VDACC object 21 plus twice the differential value. Half of this total differential value is above the display field and half is below. However, since the size of the viewable area of the VDACC object 21 has changed the effective control range of the scroller 22 has changed. Referring to FIG. 5D, the new effective control range has changed to sixteen lines in response to the change in the size of the viewable area of the VDACC object 21 instead of the previous twenty-six lines. In the example, the first control limit at line 738 is set by subtracting three lines from line 741 and the second control limit at line 753 is set by adding three lines to line 750.

Similarly, in FIGS. 4E and 5E, the effective control range of the scroller 22 is increased when the viewable area of the VDACC object 21 has been increased, for example, from twenty lines to thirty lines. As depicted in FIG. 4E, the viewable area of the VDACC object 21 has been enlarged such that thirty lines are now displayed. The thirty lines span from line 741 to line 770 and are centered at line 755.5. Using the fixed differential technique, the new effective control range is still equal to the viewable area of the VDACC object 21 plus twice the differential value. However, since the size of the viewable area of the VDACC object 21 has changed the effective control range of the scroller 22 has also changed. Referring to FIG. 5E, the new effective control range of the scroller 22 has changed to thirty-six lines in response to the change in the size of the viewable area of the VDACC object 21. In the example, the first control limit at line 738 is set by subtracting three lines from line 741 and the second control limit at line 773 is set by adding three lines to line 770.

In accordance with an embodiment of the invention, the differential value is programmed to a desired value and may be changed by the user as needed. Additionally, the differential technique can be implemented by defining a single differential value that is used to establish both control limits or by defining specific differential values for the two different control limits (e.g., separate upper and lower differential values).

When the workspace surface of a VDACC object being displayed is large, it is often desirable to mark a particular location of interest in the workspace surface so that the location of interest can be quickly found at a later time. This is achieved by placing a scroller marker at a position on the scroller of the VDACC object that corresponds to the location of interest. Since the sensitivity of the scroller of the VDACC object is greater when the effective control range of the scroller is decreased, the highest accuracy in the placement of the marker may be only possible when the effective control range has been decreased using one of the methods described above. This is because if there is more resolution, then the scroller marker can be more accurately placed. In an embodiment, the marker is placed on the scroller at a position on the scroller track that corresponds to the location of interest when the scroller has the original effective control range, not the current effective control range. Thus, when the scroller is returned to its original effective control range, the location of interest can be easily found and displayed using the marker.

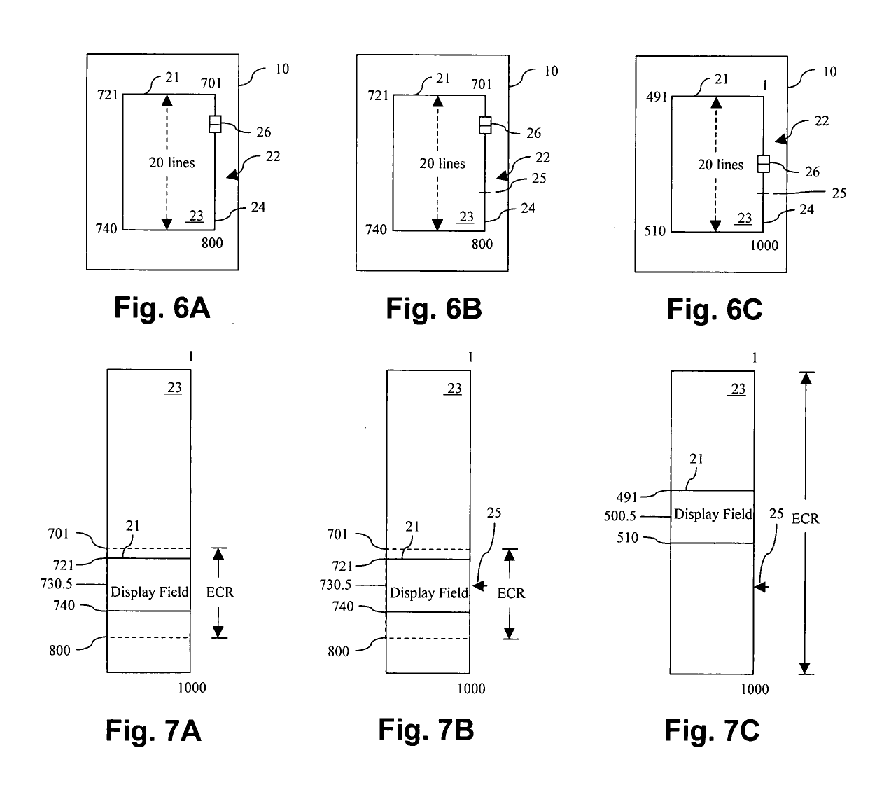

An exemplary method for using a scroller marker in conjunction with a scroller in accordance with the invention is described with reference to FIGS. 6A-6C and 7A-7C. For description purposes, it is assumed that FIGS. 6A-6C and 7A-7C are continuations of FIGS. 2C and 3C. Referring to FIGS. 6A and 7A, the scroller 22 is still in the second effective control range (e.g., from line 701 to line 800) and the scroller cap 26 has been graphically moved up the scroller track 24 such that the viewable area of the VDACC object 21 includes lines 721-740, with a center at line 730.5. For description purposes, it is also assumed that the current location of the scroller cap 26, which corresponds to line 730.5, is a location of interest. In order to identify line 730.5 as a location of interest, a user command is initiated that causes a scroller marker 25 to be associated with the location of interest. As an example, the user command may be a double left mouse click on the scroller cap 26. Referring to FIG. 6B, in response to a user command, the scroller marker 25 is placed at the location of interest on the scroller track 24. The scroller marker 25 is also shown in FIG. 6C as an arrow so that the position of the scroller marker can be viewed with respect to the entire workspace surface 23 of the VDACC object 21. However, the scroller marker 25 is not placed where the current scroller cap 26 is located, but at a position in the original effective control range of the scroller 22 that corresponds to the current scroller cap location. Thus, in this example, the marker 25 is placed on the scroller track 24 at a position that corresponds to the scroller cap location for line 730.5 when the effective control range of the scroller 22 is between line 1 and line 1000, i.e., the original effective control range of the scroller 22. After the scroller marker 25 is set, the scroller 22 can continue to be used to scroll through the current effective control range without impacting the position of the scroller marker. When the scroller 22 is returned back to the original effective control range, the position of the scroller marker 25 on the scroller 22 will not be changed, as illustrated in FIGS. 6C and 7C. Thus, the user can jump to the location of interest (i.e., line 730.5) using the marker 25.

In other embodiments, the position of the scroller marker 25 may be relative to the current effective control range of the scroller 22. In these embodiments, when the scroller marker 25 was initially created, the position of the scroller marker will correspond to the current location of the scroller cap 26, rather the would-be location of the scroller cap in the original effective control range. Furthermore, when the effective control range of the scroller 22 is changed, the position of the scroller marker 25 will change accordingly or disappear if the scroller marker is outside of the new effective control range.

Although the methods for changing the sensitivity of a scroller have been described with respect to a vertical scroller of a VDACC object, the same methods can be applied to any type of scrollers, including a horizontal scroller of a VDACC object. Thus, for a VDACC object having both a vertical scroller and a horizontal scroller, the methods can be applied individually or collectively to the vertical and horizontal scrollers.

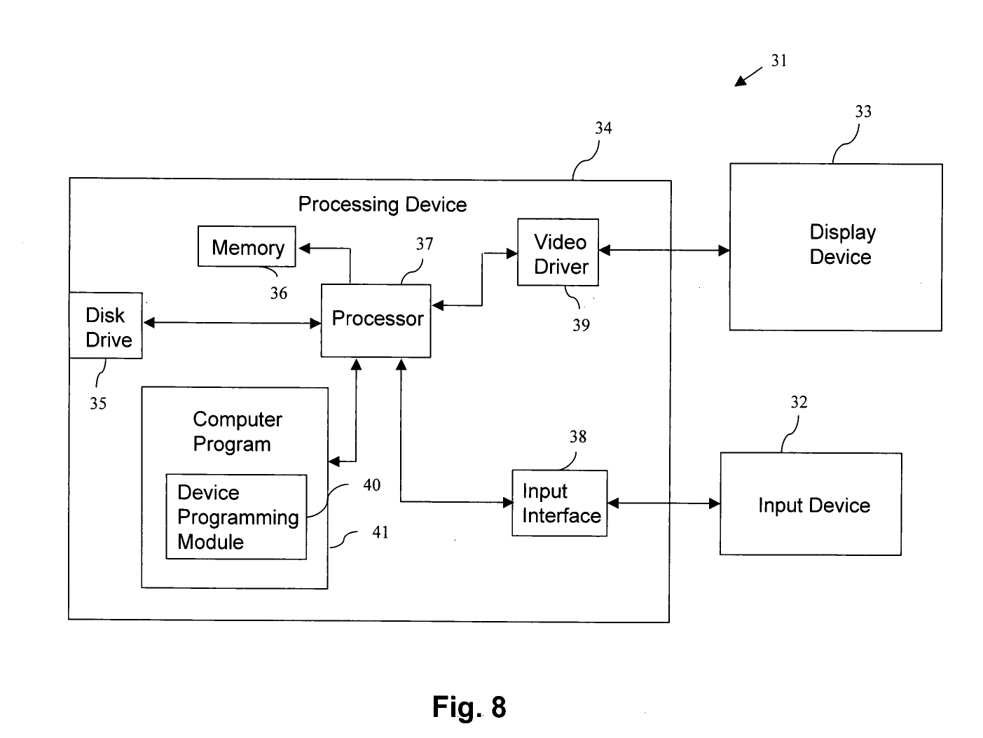

Turning now to FIG. 8, a computer system 31 in which a method for changing the sensitivity of graphic control devices in accordance with an embodiment of the invention has been implemented is shown. The computer system 31 may be a personal computer, a personal digital assistant (PDA) or any computing system with a display device. In one embodiment, the method may be embodied in a computer readable storage medium, such as a CD, that includes instructions, which can be executed by the computer system 31, to implement the method in the system.

As illustrated in FIG. 8, the computer system 31 includes an input device 32, a display device 33 and a processing device 34. Although these devices are shown as separate devices, two or more of these devices may be integrated together. The input device 32 allows a user to input commands into the system 31 to, for example, enter numeric and/or textual characters that are to be used to program one or more graphic control devices. The input device 32 may include a computer keyboard and a mouse. However, the input device 32 may be any type of electronic input device, such as buttons, dials, levers and/or switches on the processing device 34. Alternatively, the input device 32 may be part of a touch-sensitive display that allows a user to input commands using a stylus. The display device 33 may be any type of a display device, such as those found in personal computer systems, e.g., CRT monitors or LCD monitors.

The processing device 34 of the computer system 31 includes a disk drive 35, memory 36, a processor 37, an input interface 38, and a video driver 39. The processing device 34 further includes a device programming module 40, which performs various steps of the method. As shown in FIG. 8, the device programming module 40 may be implemented as part of a computer program 41, e.g., a Blackspace program that provides the Blackspace operating environment. In one embodiment, the device programming module 40 is implemented as software. However, the device programming module 40 may be implemented in any combination of hardware, firmware and/or software.

The disk drive 35, the memory 36, the processor 37, the input interface 38 and the video driver 39 are components that are commonly found in personal computers. The disk drive 35 provides a means to input data and to install programs into the system 31 from an external computer readable storage medium. As an example, the disk drive 35 may a CD drive to read data contained therein. The memory 36 is a storage medium to store various data utilized by the computer system 31. The memory 36 may be a hard disk drive, read-only memory (ROM) or other forms of memory. The processor 37 may be any type of digital signal processor that can run the computer program 41, including the device programming module 40. The input interface 38 provides an interface between the processing device 34 and the input device 32. The video driver 39 drives the display device 33. In order to simplify the figure, additional components that are commonly found in a processing device of a personal computer system are not shown or described.

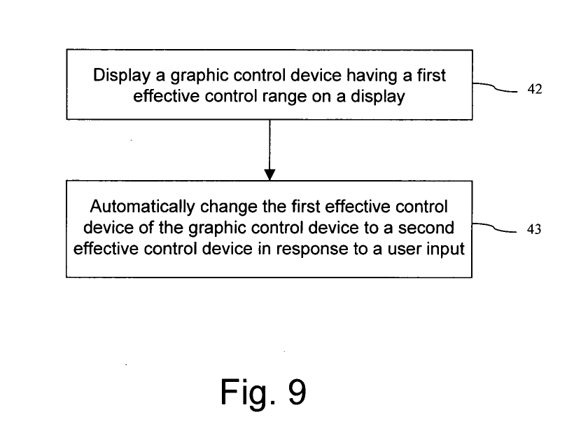

A method for programming graphic control devices, such as faders and scrollers, in accordance with an embodiment of the invention is described with reference to a flow diagram of FIG. 9. At step 42, a graphic control device having a first effective control range is displayed on a display, where the first effective control range has corresponding first and second control limits. Next, at step 43, the first effective control range of the graphic control device is automatically changed to a second effective control range in response to a user input, where the second effective control range has corresponding first and second control limits.

Although specific embodiments of the invention have been described and illustrated, the invention is not to be limited to the specific forms or arrangements of parts so described and illustrated. The scope of the invention is to be defined by the claims appended hereto and their equivalents.

1. A method for changing the sensitivity of a graphic control device comprising:
displaying said graphic control device having a first effective control range on a display, said first effective control range having corresponding first and second control limits; and
automatically changing said first effective control range of said graphic control device to a second effective control range in response to a user input, said second effective control range having corresponding first and second control limits.

2. The method of claim 1 further including variably programming said first effective control range.

3. The method of claim 1 wherein said automatically changing of said first effective control range to said second effective control range includes changing said second effective control range by a scaling factor of said first effective control range.

4. The method of claim 3 further including programming said scaling factor through a graphical user interface.

5. The method of claim 3 further comprising automatically changing said second effective control range of said graphic control device to said first effective control range in response to a second user input.

6. The method of claim 1 further comprising changing said second effective control range of said graphic control device by changing the displayed size of said graphic control device.

7. The method of claim 1 wherein said graphic control device includes a fader that is controllable using a graphical user interface.

8. The method of claim 1 wherein said graphic control device includes a scrolling element that is controllable through a graphical user interface.

9. The method of claim 1 wherein said graphic control device is part of a graphic object having a surface that is larger than a viewable area of said graphic object, said graphic control device being configured to move said viewable area of said graphic object to view different portions of said surface.

10. The method of claim 9 wherein said automatically changing of said first effective control range of said graphic control device to said second effective control range includes changing said first effective control range of said graphic control device to said second effective control range such that said second effective control range is defined by said viewable area of said graphic object and a fixed differential value.

11. The method of claim 9 further comprising:
selecting a location of interest on said surface of said graphic object using said graphic control device having said second effective control range; and
displaying a marker on said graphic control device having said second effective control range at a position that corresponds to said location of interest, said position being relative to said graphic control device having said first effective control range.

12. A storage medium readable by a computer, tangibly embodying a program of instructions executable by said computer to perform method steps for changing the sensitivity of a graphic control device, said method steps comprising:
displaying said graphic control device having a first effective control range on a display, said first effective control range having corresponding first and second control limits; and
automatically changing said first effective control range of said graphic control device to a second effective control range in response to a user input, said second effective control range having corresponding first and second control limits.

13. The storage medium of claim 12 further including variably programming said first effective control range.

14. The storage medium of claim 12 wherein said automatically changing of said first effective control range to said second effective control range includes changing said second effective control range by a scaling factor of said first effective control range.

15. The storage medium of claim 14 further including programming said scaling factor through a graphical user interface.

16. The storage medium of claim 14 further comprising automatically changing said second effective control range of said graphic control device to said first effective control range in response to a second user input.

17. The storage medium of claim 12 further comprising changing said second effective control range of said graphic control device by changing the displayed size of said graphic control device.

18. The storage medium of claim 12 wherein said graphic control device includes a fader that is controllable using a graphical user interface.

19. The storage medium of claim 12 wherein said graphic control device includes a scrolling element that is controllable through a graphical user interface.

20. The storage medium of claim 12 wherein said graphic control device is part of a graphic object having a surface that is larger than a viewable area of said graphic object, said graphic control device being configured to move said viewable area of said graphic object to view different portions of said surface.

21. The storage medium of claim 20 wherein said automatically changing of said first effective control range of said graphic control device to said second effective control range includes changing said first effective control range of said graphic control device to said second effective control range such that said second effective control range is defined by said viewable area of said graphic object and a fixed differential value.

22. The method of claim 20 further comprising:
selecting a location of interest on said surface of said graphic object using said graphic control device having said second effective control range; and
displaying a marker on said graphic control device having said second effective control range at a position that corresponds to said location of interest, said position being relative to said graphic control device having said first effective control range.

23. A system for changing the sensitivity of a graphic control device comprising:
a display configured to display said graphic control device having a first effective control range, said first effective control range having corresponding first and second control limits; and
a device programming module configured to automatically change said first effective control range of said graphic control device to a second effective control range in response to a user input, said second effective control range having corresponding first and second control limits.

24. The system of claim 23 wherein said device programming module is configured to allow a user to variably program said first effective control range.

25. The system of claim 23 wherein said device programming module is configured to change said second effective control range of said graphic control device by a scaling factor of said first effective control range.

26. The system of claim 25 wherein said scaling factor used to define said second effective control range of said graphic control device is modifiable by a user.

27. The system of claim 25 wherein said device programming module is configured to change said second effective control range of said graphic control device to said first effective control range in response to a second user input.

28. The system of claim 23 wherein said device programming module is configured to change said second effective control range of said graphic control device when said displayed size of said graphic control device is changed.

29. The system of claim 23 wherein said graphic control device includes a fader that is controllable using a graphical user interface.

30. The system of claim 23 wherein said graphic control device includes a scrolling element that is controllable through a graphical user interface.

31. The system of claim 23 wherein said graphic control device is part of a graphic object having a surface that is larger than a viewable area of said graphic object, said graphic control device being configured to move said viewable area of said graphic object to view different portions of said surface.

32. The system of claim 31 wherein device programming module is configured to change said first effective control range of said graphic control device to said second effective control range such that said second effective control range is defined by said viewable area of said graphic object and a fixed differential value.

33. The system of claim 31 wherein device programming module is configured to display a marker on said graphic control device having said second effective control range at a position that corresponds to a location of interest on said surface of said graphic control device in response to a selection of said location of interest by a user, said position being relative to said graphic control device having said first effective control range.
